(19) United States
(12) Patent Application Publication
(10) Pub. No.: US 2009/0179804 A1
(43) Pub. Date: Jul. 16, 2009

(54) Antenna module

(75) Inventor: Ming-Yen Liu, Taipei (TW)

Correspondence Address: BACON & THOMAS, PLLC, 625 SLATERS LANE, FOURTH FLOOR, ALEXANDRIA, VA, 22314-1176, US

(73) Assignee: ASUSTek COMPUTER INC., Taipei (TW)

(21) Appl. No.: 12/285,590

(22) Filed: Oct. 9, 2008

(30) Foreign Application Priority Data
Jan. 14, 2008 (TW) 97101355

(51) Int. Cl. H01Q 1/38

(52) U.S. Cl. 343/700 MS

(57) ABSTRACT

An antenna module includes a dielectric substrate, a grounding element, a transmission element and a radiating element. The dielectric substrate has a first surface and a second surface. The grounding element is disposed on the first surface. The transmission element and the radiating element are disposed on the second surface. The radiating element includes a first sub-radiating element having a first side and a second side. The first sub-radiation element is connected to the transmission element at the first side, and the width of the first sub-radiating element gradually becomes larger from the first side toward the second side.

This application claims the benefit of Taiwan application Serial No. 0 97101355, filed Jan. 14, 2008, the subject matter of which is incorporated herein by reference.

### BACKGROUND OF THE INVENTION

1. Field of the Invention

The invention relates to an antenna module and, more particularly, to an antenna module having a wide bandwidth characteristic.

2. Description of the Related Art

Along with the development of the wireless communication technology, more and more electronic products have various communication functions. The wireless communication is various, such as the wireless wide area network (WWAN), the wireless metropolitan area network (WMAN), the wireless local area network (WLAN), the wireless personal area network (WPAN) or the Bluetooth, and each type of communication has its corresponding operating bandwidth.

The wireless communication technology employs various antennas to receive or send signals of corresponding bandwidths. When a radio system operates within multiple bandwidths, most antennas utilize a plurality of groups of independent antennas to achieve the objective of antenna diversity. However, in this way, the complexity of the system rises greatly, and the space utilization ration drops greatly.

Even if two groups of antennas are combined to form a complex antenna, the interference between the two groups of antennas often seriously affects the radiating bandwidth. The original performance of each group of antenna even reduces.

### BRIEF SUMMARY OF THE INVENTION

The invention is related to an antenna module, and the antenna module has a wide bandwidth characteristic via the design of shapes of a radiating element and a grounding element.

According to one aspect of the invention, an antenna module is provided. The antenna module includes a dielectric substrate, a grounding element, a transmission element and a radiating element. The dielectric substrate has a first surface and a second surface. The grounding element is disposed at the first surface. The transmission element and the radiating element are disposed at the second surface. The radiating element includes a first sub-radiating element. The first sub-radiating element has a first side and a second side. The first sub-radiating element is connected to the transmission element at the first side, and the width of the first sub-radiating element gradually becomes larger from the first side toward the second side.

By gradually increasing the width of the first sub-radiating element, the equivalent impedance of the first sub-radiating element is generally equal to the impedance of the transmission process when wireless signals from the lowest frequency to the highest frequency are transmitted. Therefore, the feedback quantity of the wireless signals of the whole bandwidth is below a standard value defined by a used protocol to obtain a wide bandwidth effect when the wireless signals from the lowest frequency to the highest frequency are transmitted.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a schematic diagram showing an antenna module of the first embodiment of the invention;

FIG. 2A is a top view showing the antenna module in FIG. 1;

FIG. 2B is a schematic diagram showing the relationship between the radiating element, the grounding element and the transmission element and the first surface of the antenna module in FIG. 1;

FIG. 3 is a schematic diagram showing a return loss measurement chart of the antenna module in FIG. 1;

FIG. 4 is a top view showing an antenna module of the second embodiment of the invention;

FIG. 5 is a top view showing an antenna module of the third embodiment of the invention;

FIG. 6 is a top view showing an antenna module of the fourth embodiment of the invention; and

FIG. 7 is a top view showing an antenna module of the fifth embodiment of the invention.

### DETAILED DESCRIPTION OF THE EMBODIMENTS

### First Embodiment

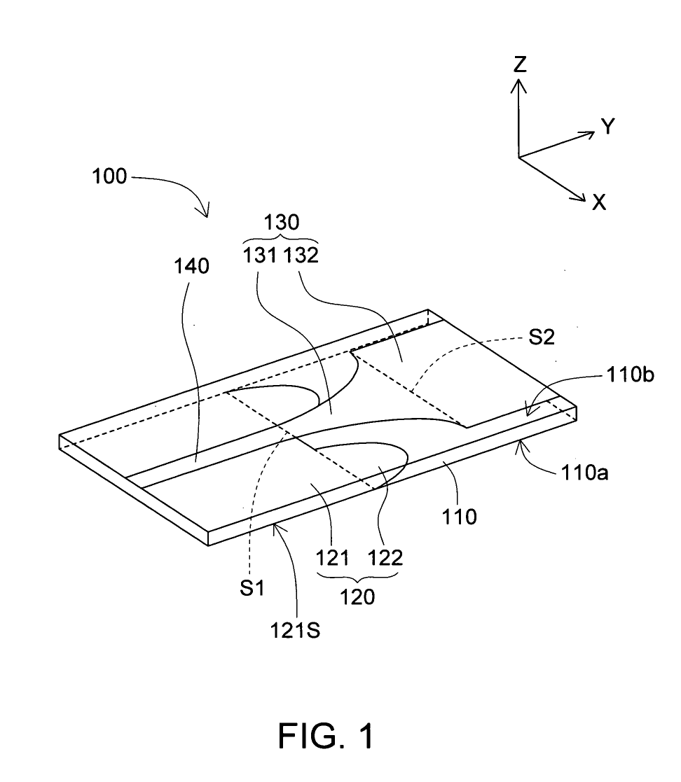

FIG. 1 is a schematic diagram showing an antenna module 100 of the first embodiment of the invention. The antenna module 100 includes a dielectric substrate 110, a grounding element 120, a transmission element 140 and a radiating element 130. The dielectric substrate 110 is made of, for example, epoxide resin or fiberglass. The dielectric substrate 110 has a first surface 110a and a second surface 110b. The grounding element 120 is disposed at the first surface 110a. The transmission element 140 and the radiating element 130 are disposed at the second surface 110b. The grounding element 120, the transmission element 140 and the radiating element 130 may be, for example, printed metal layers or additionally attached metal sheets.

The radiating element 130 at least includes a first sub-radiating element 131. The first sub-radiating element 131 has a first side S1 and a second side S2 opposite to the first side S1 (in FIG. 1, the first side S1 and the second side S2 are denoted with broken lines). The first sub-radiating element 131 is connected to the transmission element 140 at the first side S1, and the width of the first sub-radiating element 131 gradually becomes larger from the first side S1 toward the second side S2.

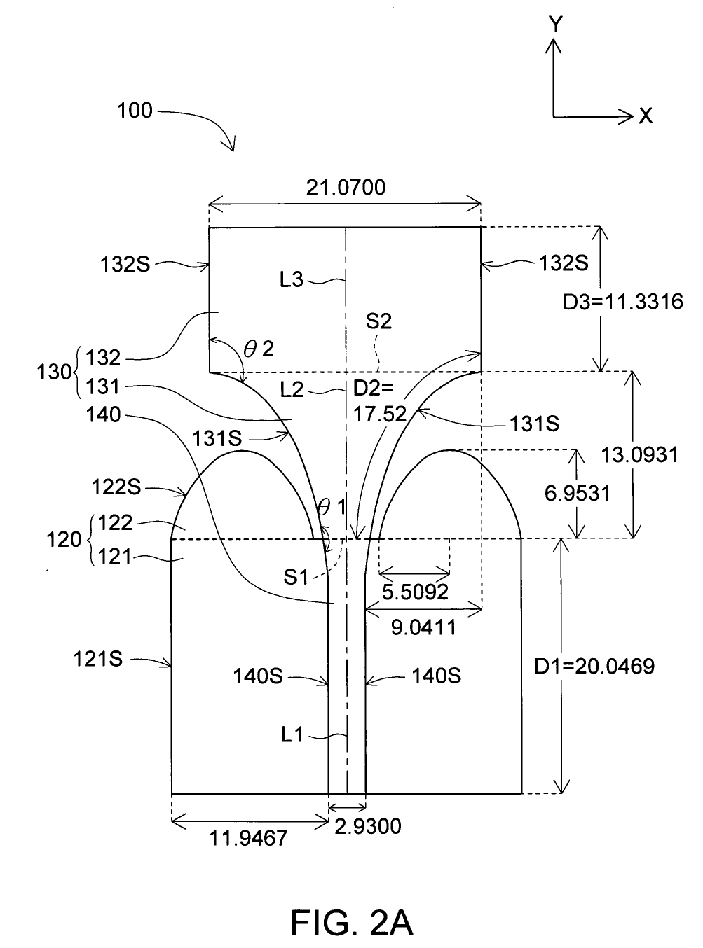

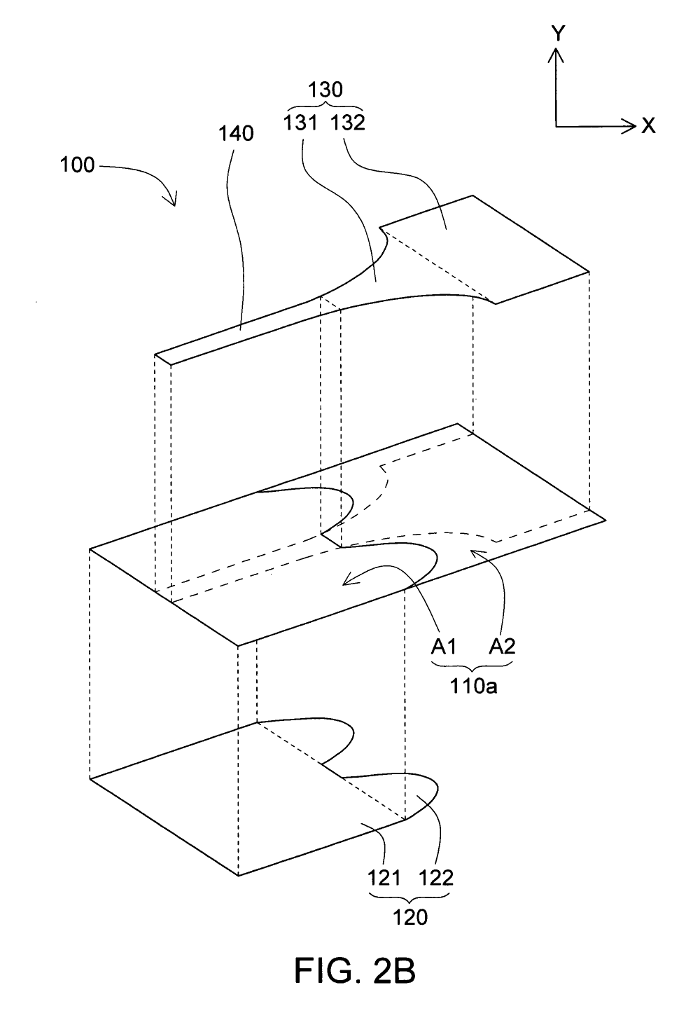

FIG. 2A is a top view showing the antenna module 100 in FIG. 1. In detail, the transmission element 140 has a transmission edge 140S, and the first sub-radiating element 131 has a first radiating edge 131S. The transmission edge 140S is connected to the first radiating edge 131S, and the first radiating edge 131S connects the first side S1 with the second side S2.

In the embodiment, the transmission element 140 has two transmission edges 140S, and the first sub-radiating element 131 has two first radiating edges 131S. The two transmission edges 140S are symmetric with respect to a central axis L1 of the transmission element 140. The two first radiating edges 131S are symmetric with respect to a symmetric axis L2 of the first sub-radiating element 131. That is, the transmission element 140 and the first sub-radiating element 131 of the embodiment are symmetric structures.

The first radiating edge 131S is a smooth curve in shape. The two first radiating edges 131S are close to each other at the first side S1, and they are far away from each other at the second side S2. That is, the distance between the two first radiating edges 131S at the first side S1 is smaller than the distance between the two first radiating edges 131S at the second side S2. The distance between the two first radiating edges 131S gradually increases from the first side S1 toward the second side S2. That is, the first sub-radiating element 131 is crateriform.

The smooth curve is, for example, part of an elliptical curve, part of a circular curve, part of a parabolic curve or other curve. In the embodiment, each of the first radiating edges 131S is a quarter elliptical curve in shape. The elliptical curve has a major axis and a minor axis, and the ratio of the major axis and the minor axis is between 1.3 and 3. The ratio of the major axis and the minor axis preferably is between 1.5 and 2.

The angle θ1 between the transmission edge 140S and the first radiating edge 131S is greater than ninety degrees. That is, the transmission edge 140S and the first radiating edge 131S do not form a sharp angle at their connection place. The transmission edge 140S and the first radiating edge 131S may be smooth straight lines or smooth curves, and the connection place of the transmission edge 140S and the first radiating edge 131S also is smooth. In this way, wireless signals can be smoothly emitted out (or fed in), and they cannot be greatly fed back (or reflected) at some position.

The radiating element 130 of the embodiment further includes a second sub-radiating element 132. The second sub-radiating element 132 has a second radiating edge 132S, and the second radiating edge 132S is connected to the first radiating edge 131S. The second radiating edge 132S is a straight line in shape. The second sub-radiating element 132 of the embodiment may be a rectangular structure. The second sub-radiating element 132 is used to adjust the corresponding equivalent impedance of the first sub-radiating element 131 at the second side S2 to allow the first sub-radiating element 131 to satisfy an impedance matching requirement at the second side S2.

In the embodiment, the angle θ2 between the second radiating edge 132S and the first radiating edge 131S also is greater than ninety degrees. The transmission edge 140S, the first radiating edge 131S and the second radiating edge 132S may be straight lines or smooth curves in shape, and the transmission edge 140S, the first radiating edge 131S and the second radiating edge 132S do not form sharp angles at their connection places (the connection places even are smooth). Therefore, the wireless signals can be smoothly emitted out (or fed in), and they cannot be greatly fed back (or reflected) at some position.

The second sub-radiating element 132 has two second radiating edges 132S, and the two second radiating edges 132S are symmetric with respect to the symmetric axis L3 of the second sub-radiating element 132. Therefore, the second sub-radiating element 132 also is a symmetric structure.

As shown in FIG. 1 and FIG. 2A, as for the grounding element 120, it includes a first sub-grounding element 121 and at least a second sub-grounding element 122. The transmission element 140 is disposed above the first sub-grounding element 121. The first sub-grounding element 121 has a first grounding edge 121S. In the embodiment, the first sub-grounding element 121 is a rectangular structure. The area of the first sub-grounding element 121 is larger than the area of the transmission element 140.

The second sub-grounding element 122 is connected to the first sub-grounding element 121. The second sub-grounding element 122 has a grounding edge 122S. The grounding edge 122S is connected to the top of the first sub-grounding element 121.

FIG. 2B is a schematic diagram showing the relationship between the radiating element 130, the grounding element 120 and the transmission element 140 and the first surface 110a of the antenna module 100 in FIG. 1. The first surface 110a where the grounding element 120 is disposed is divided into a first area A1 and a second area A2. The grounding element 120 (including the first sub-grounding element 121 and the second sub-grounding element 122) is disposed in the first area A1, and the second area A2 is the other area of the first surface 110a except the first area A1. As shown in FIG. 2B, the transmission element 140 is disposed above the first area A1. The first sub-radiating element 131 and the second sub-radiating element 132 are disposed above the second area A2. That is, the transmission element 140 overlaps the grounding element 120. The first sub-radiating element 131 and the second sub-radiating element 132 do not overlap the grounding element 120.

The grounding element 120 of the embodiment includes two second grounding elements 122. The two second grounding elements 122 are located at two sides of the first sub-radiating element 131, respectively. The grounding edge 122S is adjacent to the first radiating edge 131S. The grounding edge 122S is preferred to be similar to the first radiating edge 131S in shape. Then, when the wireless signals form a resonance mode between the first radiating edge 131S and the grounding edge 122S, the energy of the wireless signals can be maintained at a certain degree and not be lost.

In the embodiment, the first radiating edge 131S is a quarter elliptical curve, and the grounding edge 122S also is part of an elliptical curve in shape and is preferred to be a half of an elliptical curve in shape.

In the embodiment, the transmission element 140S has a first distance D1 of, for example, 20.0469 millimeters.

The first radiating edge 131S has a semi-major axis of, for example, 13.0931 millimeters and a semi-minor axis of, for example, 9.0411 millimeters. That is, the ratio of the major axis to the minor axis is about 1.45. The first radiating edge 131S has a second length D2 of, for example, 17.52 millimeters. The width of the first sub-radiating element 131 at the first side S1 is, for example, 2.9300 millimeters, and the width of the first sub-radiating element 131 at the second side S2 is, for example, 21.0700 millimeters.

The second radiating edge 132S of the second sub-radiating element 132 has a third length D3 of, for example, 11.3316 millimeters.

The length and width of the first sub-grounding element 121 are 26.8234 millimeters and 20.0469 millimeters, respectively.

Each of the second sub-grounding elements 122 is a half of an ellipse in shape, the semi-major axis and the semi-minor axis of the ellipse are, for example, 6.9531 millimeters and 5.5092 millimeters, respectively.

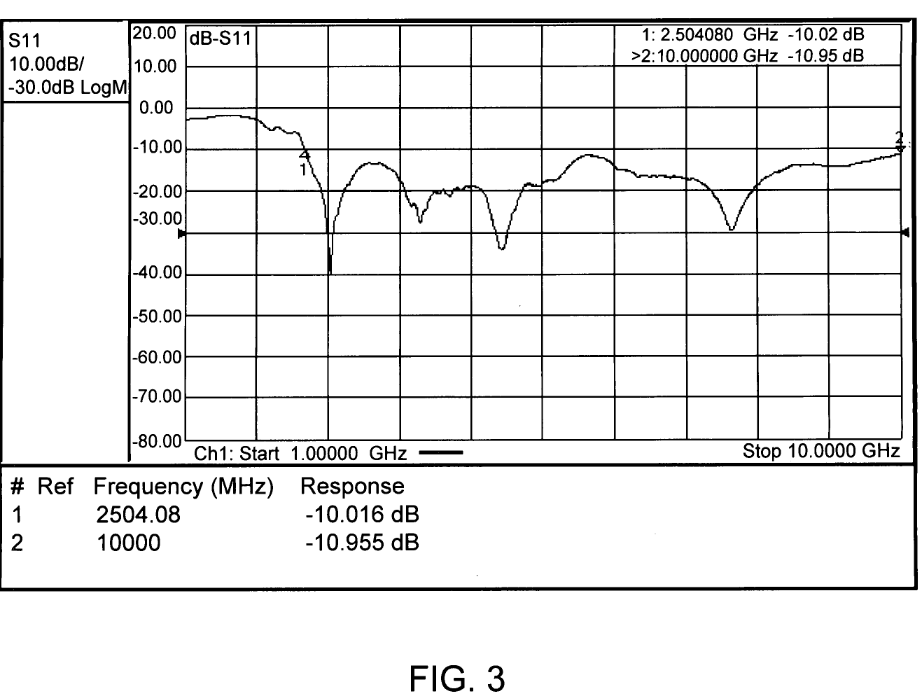

FIG. 3 is a schematic diagram showing a return loss measurement chart of the antenna module 100 in FIG. 1. Generally speaking, the radiation wavelength that the antenna module 100 can operate with is determined by equation (1):

$$λ = \frac{1}{4} * 30 ( cm ) * \frac{1}{f ( GHz )} * \frac{1}{\sqrt{{ɛ}_{r}}} \qquad ( 1 )$$

Wherein λ is the wavelength, f is the frequency, and εᵣ is the dielectric coefficient. Therefore, the lowest frequency that the antenna module 100 can operate at is determined by the sum of the second length D2 and the third length D3 (that is, 17.52+11.3316=28.8516 millimeters).

In the whole bandwidth, when the wireless signal having the lowest frequency is transmitted, the equivalent impedance of the first sub-radiating element 131 is related to the greatest width (at the second side S2) of the first sub-radiating element 131. When the wireless signal having the highest frequency is transmitted, the equivalent impedance of the first sub-radiating element 131 is related to the smallest width (at the first side S1) of the first sub-radiating element 131. When a wireless signals having an intermediate frequency between the highest frequency and the lowest frequency is transmitted, the equivalent impedance of the first sub-radiating element 131 is related to a middle width (which is located between the first side S1 and the second side S2) between the greatest width and the smallest width.

By gradually increasing the width of the first sub-radiating element 131, the equivalent impedance of the first sub-radiating element 131 is generally equal to the impedance of the transmission process when wireless signals from the lowest frequency to the highest frequency are transmitted. Therefore, the feedback quantity of the wireless signals of the whole bandwidth is below a standard value defined by a used protocol to obtain a wide bandwidth effect when the wireless signals from the lowest frequency to the highest frequency are transmitted.

As shown in FIG. 3, all return losses are below −10 dB when the antenna module operates within a bandwidth between 2.50408 GHz and 10.000 GHz. Therefore, the antenna module 100 can preferably receive wireless signals within the bandwidth between 2.50408 GHz and 10.000 GHz. Thus, the antenna module 100 is suitable for the wireless wide area network (WWAN), the wireless metropolitan area network (WMAN), the wireless local area network (WLAN), the wireless personal area network (WPAN) or the Bluetooth. For example, in the WPAN, the 802.11 protocol, the 802.11b protocol, the 802.11a protocol and the 802.11g protocol are operated at 2.4 GHz, 2.4 GHz, 5 GHz and 2.4 GHz, respectively. The antenna module 100 of the embodiment can operate at all the above frequencies.

### Second Embodiment

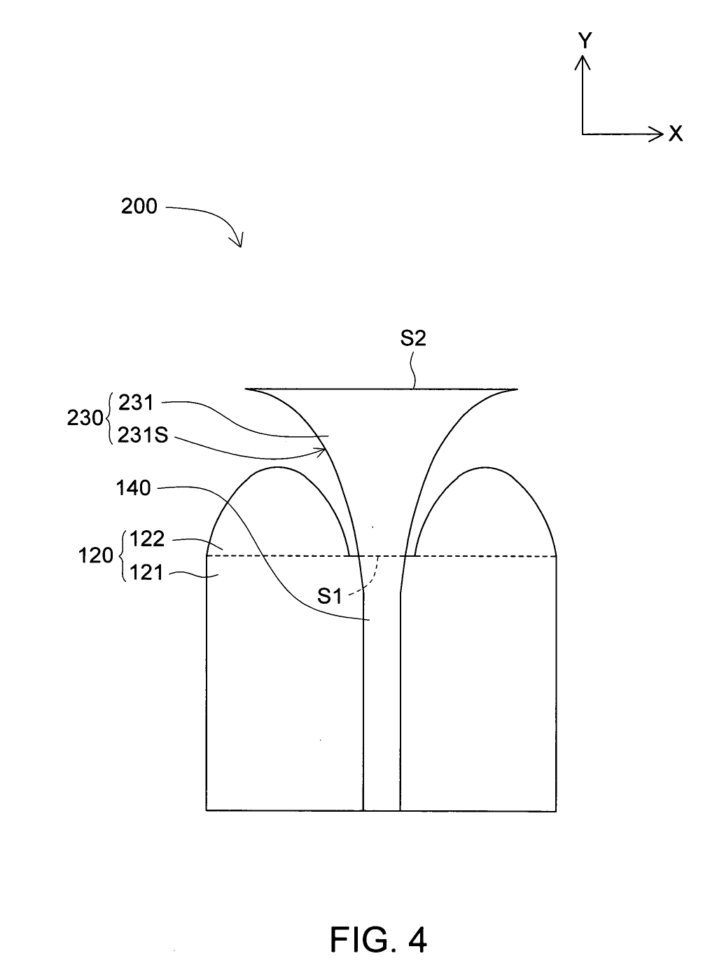

FIG. 4 is a top view showing an antenna module 200 of the second embodiment of the invention. The difference between the antenna module 200 of the embodiment and the antenna module 100 of the first embodiment is that the radiating element 230 of the embodiment does not have the second sub-radiating element 132, and the same components are not described for concise purpose.

Designers can extend lengths of the first sub-radiating element 231 and the first radiating edge 231S and remove the second sub-radiating element 132 according to a design requirement. Under the condition that the width of the first sub-radiating element 231 gradually increases from the first side S1 toward the second side S2, the first sub-radiating element 231 satisfies with the impedance matching at every point. Any point of the first sub-radiating element 231 between the first side S1 and the second side S2 can cooperate with the grounding element 120 to generate a good resonance mode to obtain a wide bandwidth effect.

### Third Embodiment

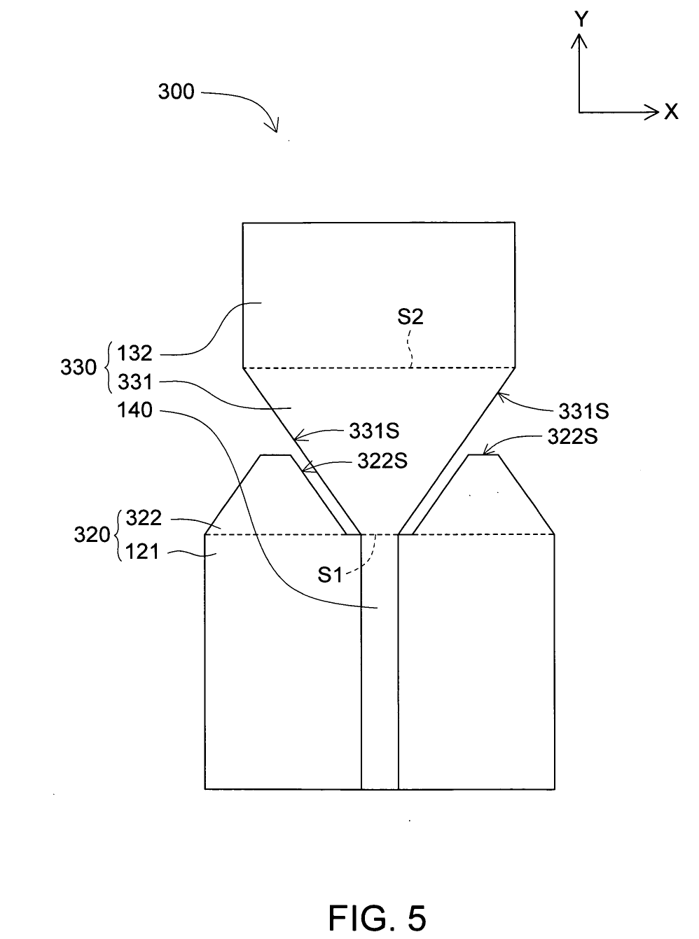

FIG. 5 is a top view showing an antenna module 300 of the third embodiment of the invention. The difference between the antenna module 300 of the embodiment and the antenna module 100 of the first embodiment is shapes of a first radiating edge 331S and a grounding edge 322S, and the same components are not described for concise purpose.

The first radiating edge 331S is a straight line in shape. That is, the first sub-radiating element 331 of the radiating element 330 is trapezoid. Under the condition that the width of the trapezoid first sub-radiating element 331 gradually increases from the first side S1 toward the second side S2, the first sub-radiating element 331 satisfies with the impedance matching at every point. Any point of the first sub-radiating element 331 between the first side S1 and the second side S2 can cooperate with the grounding element 320 to generate a good resonance mode to obtain a wide bandwidth effect.

### Fourth Embodiment

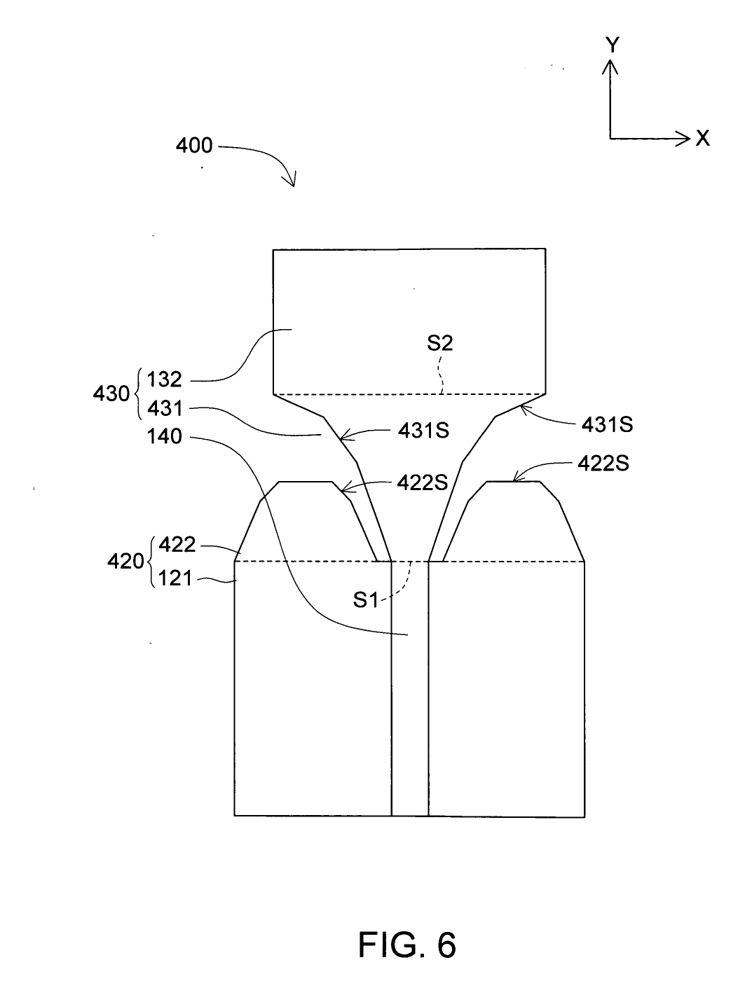

FIG. 6 is a top view showing an antenna module 400 of the fourth embodiment of the invention. The difference between the antenna module 400 of the embodiment and the antenna module 100 of the first embodiment is shapes of a first radiating edge 431S and a grounding edge 422S, and the same components are not described for concise purpose.

The first radiating edge 431S of the embodiment is a polygonal line in shape. That is, the first sub-radiating element 431 of the radiating element 430 is polygonal. Under the condition that the width of the polygonal first sub-radiating element 431 gradually increases from the first side S1 toward the second side S2, the first sub-radiating element 431 satisfies with the impedance matching at every point. Any point of the first sub-radiating element 431 between the first side S1 and the second side S2 can cooperate with the grounding element 420 to generate a good resonance mode to obtain a wide bandwidth effect.

### Fifth Embodiment

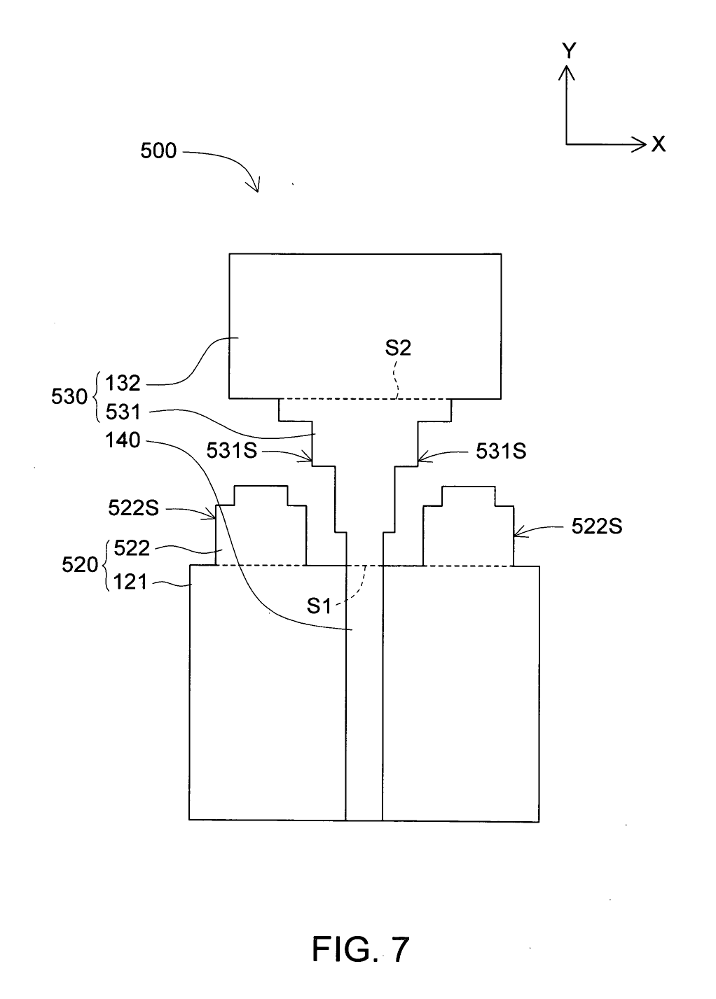

FIG. 7 is a top view showing an antenna module 500 of the fifth embodiment of the invention. The difference between the antenna module 500 of the embodiment and the antenna module 100 of the first embodiment is shapes of a first radiating edge 531S and a grounding edge 522S, and the same components are not described for concise purpose.

The first radiating edge 531S of the embodiment is stepped. Under the condition that the width of the stepped first sub-radiating element 531 gradually increases from the first side S1 toward the second side S2, the first sub-radiating element 531 satisfies with the impedance matching at every point. Any point of the first sub-radiating element 531 between the first side S1 and the second side S2 can cooperate with the grounding element 520 to generate a good resonance mode to obtain a wide bandwidth effect.

The antenna module of the embodiment of the invention employs the design of the shapes of the radiating element and the grounding element to allow the antenna module to obtain the wide bandwidth effect. Furthermore, the antenna module of the embodiment is a type of circuit board, and it can be directly used on the circuit board that an electronic device originally has. Then, the antenna module has a low manufacture cost and can be conveniently assembled.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An antenna module comprising:
a dielectric substrate having a first surface and a second surface;
a grounding element disposed at the first surface;
a transmission element disposed at the second surface; and
a radiating element disposed at the second surface and including:
a first sub-radiating element having a first side and a second side, wherein the first sub-radiating element is connected to the transmission element at the first side, and the width of the sub-radiating element gradually increases from the first side toward the second side.

2. The antenna module according to claim 1, wherein the first surface is divided into a first area and a second area, the grounding element is disposed at the first area, the second area is the other area of the first surface except the first area, the transmission element is disposed above the first area, and the first sub-radiating element is disposed above the second area.

3. The antenna module according to claim 1, wherein the transmission element comprises a transmission edge, the first sub-radiating element has a first radiating edge, the first radiating edge connects the first side with the second side, and the first transmission edge is connected to the first radiating edge.

4. The antenna module according to claim 1, wherein the first sub-radiating element comprises a first radiating edge, the first radiating edge connects the first side with the second side, and the first radiating edge is a smooth curve in shape.

5. The antenna module according to claim 4, wherein the first sub-radiating element has two opposite first radiating edges, the two first radiating edges are symmetric with respect to a symmetric axis of the first sub-radiating element.

6. The antenna module according to claim 4, wherein the first radiating edge is part of an elliptical curve in shape.

7. The antenna module according to claim 4, wherein the radiating element further comprises a second sub-radiating element having a second radiating edge, and the second radiating edge is connected to the first radiating edge and is a straight line in shape.

8. The antenna module according to claim 7, wherein the second sub-radiating element is rectangular.

9. The antenna module according to claim 7, wherein the transmission element has a transmission edge, the transmission edge is connected to the first radiating edge and has a first length, the first radiating edge has a second length, the second radiating edge has a third length, and the sum of the second length and the third length is relative to the lowest operating frequency of the antenna module.

10. The antenna module according to claim 1, wherein the first sub-radiating element has a first radiating edge, the first radiating edge connects the first side with the second side and is a straight line in shape.

11. The antenna module according to claim 1, wherein the first sub-radiating element has a first radiating edge, the first radiating edge connects the first side with the second side and is a polygonal line in shape.

12. The antenna module according to claim 1, wherein the first sub-radiating element has a first radiating edge, the first radiating edge connects the first side with the second side and is stepped.

13. The antenna module according to claim 1, wherein the grounding element comprises:
a first sub-grounding element, the transmission element is disposed above the first sub-grounding element; and
as least a second sub-grounding element connected to the first sub-grounding element, wherein the second sub-grounding element has a grounding edge connected to the top of the first sub-grounding element, the first sub-radiating element has a first radiating edge, the first radiating edge connects the first side with the second side of the first sub-radiating element, and the grounding edge is adjacent to the first radiating edge.

14. The antenna module according to claim 13, wherein the grounding edge is a smooth curve in shape.

15. The antenna module according to claim 13, wherein the grounding edge is part of an elliptical curve in shape.

16. The antenna module according to claim 13, wherein the grounding edge is similar to the first radiating edge in shape.

17. The antenna module according to claim 13, wherein the grounding element comprises two second sub-grounding elements, and the two second sub-grounding elements are located at two sides of the first sub-radiating element, respectively.

18. The antenna module according to claim 13, wherein the first sub-grounding element is rectangular.

19. The antenna module according to claim 13, wherein the area of the first sub-grounding element is larger than the area of the transmission element.
